(19) United States
(12) Patent Application Publication
(10) Pub. No.: US 2026/0298873 A1
(43) Pub. Date: Oct. 1, 2026

(54) MASS SPECTROMETER HAVING PARALLEL PRECURSOR ION ISOLATION

(71) Applicant: Micromass UK Limited, Wilmslow (GB)

(72) Inventors: Keith George Richardson, High Peak (GB); Martin Raymond Green, Bowdon, Cheshire (GB)

(73) Assignee: Micromass UK Limited, Wilmslow (GB)

(21) Appl. No.: 19/479,285

(22) PCT Filed: Apr. 25, 2024
(86) PCT No.: PCT/GB2024/051087

§ 371 Date: Oct. 27, 2025

(30) Foreign Application Priority Data
Apr. 27, 2023 (GB) 2306186.4

(51) Int. Cl. G01N 27/623; H01J 49/00; H01J 49/42

(52) U.S. Cl. CPC G01N 27/623; H01J 49/0031; H01J 49/009; H01J 49/4215; H01J 49/428

(57) ABSTRACT

A method of mass spectrometry comprising: providing a mass spectrometer comprising a mass filter (2), an ion mobility separator (IMS) device (3), a fragmentation or reaction device (4), and a mass analyser (5); applying voltages to the mass filter such that it simultaneously has multiple mass transmission windows that simultaneously transmit multiple respective precursor ion species to the IMS device whilst filtering out other precursor ion species; separating, in the IMS device, the precursor ion species that are simultaneously transmitted by the mass filter so as to provide different ones of the precursor ion species to the fragmentation or reaction device at different times; sequentially fragmenting or reacting the different precursor ion species in the fragmentation or reaction device so as to form fragment or product ions; detecting the fragment or product ions in the mass analyser; and associating detected fragment or product ions with their respective precursor ion species based on the times of detection of the fragment or product ions in the mass analyser.

### CROSS-REFERENCE TO RELATED APPLICATION

This application claims priority from and the benefit of United Kingdom patent application No. 2306186.4 filed on 27 Apr. 2023, the entire contents of which are incorporated herein by reference.

### FIELD OF THE INVENTION

The present invention relates generally to mass spectrometers and in particular to a high duty cycle technique for isolating precursor ions for subsequent analysis.

### BACKGROUND

Tandem mass spectrometry, which is often referred to as MSMS, is a well-known technique for the discovery, detection and quantitation of analytes in a sample. Typically, tandem mass spectrometry techniques involve ionising the sample to form precursor ions, isolating a particular precursor ion species using a resolving quadrupole mass filter, fragmenting the isolated precursor ion species so as to form fragment ions, and determining the mass to charge ratios of the fragment ions. The mass to charge ratio of the isolated precursor ion species is known, since the mass filter is set to transmit only that mass to charge ratio. The mass to charge ratio of the precursor ion species and the mass to charge ratios of its fragment ions are used to identify, detect or quantify the precursor ion species with high confidence.

The speed at which this technique may be performed enables it to be used to analyse a sample that has been separated by a separator such as by a liquid chromatography device. The mass spectrometer may be operated so as to sequentially isolate different precursor ion species at different times, as the sample elutes from the separator. Each precursor ions species is fragmented and the resulting fragment ions are mass analysed in the manner described above. The precursor ion species that are isolated may be predetermined, e.g. in Multiple Reaction Monitoring experiments (MRM), or may be determined on-the-fly, e.g. in Data Dependent Acquisition (DDA).

However, a drawback of the conventional approaches described above is that when each precursor ion species is being isolated by the mass filter, all other precursor ions species are typically filtered out and discarded. Such techniques therefore have a relatively low duty cycle. Also, the proportion of the analysis time that is able to be allocated to the analysis of any given precursor ion species is relatively low, which therefore restricts the limit of detection or quantitation for the analyte from which the precursor ion species is derived.

In order to circumvent the above limitations, the population of precursor ions being introduced to the mass spectrometer can be accumulated and then separated such that different precursor ions species are sequentially introduced into a fragmentation device so as to form fragment ions, without first mass filtering the precursor ions. The fragment ions are then mass analysed. As the precursor ion species are separated prior to their fragmentation, the fragment ion species that are detected can be associated with their respective precursor ions species based on the times at which the fragment ions species are detected, since the time at which any given fragment ion species is detected is related to the time at which its precursor ion species elutes from the separator.

If the resolution of the separation technique is insufficient, the separation device may be followed by a resolving mass filter that is scanned or stepped across the range of mass to charge ratios of interest on a timescale that is shorter than the cycle time of the separation device. Provided that the mass filter is able to isolate more than one precursor ion species within the cycle time of the separation device, there is an increase in duty cycle over techniques that do not use the precursor ion separation.

However, the techniques that are used to separate the precursor ions require the initial ion population entering the mass spectrometer to first enter an ion accumulation region in which the ions are trapped. This can be problematic, as the accumulation region has a space-charge capacity and so is only able to accumulate a certain amount of charge before space-charge effects begin to negatively influence the analysis of the ions.

### SUMMARY

From a first aspect the present invention provides a method of mass spectrometry comprising: providing a mass spectrometer comprising a mass filter, an ion mobility separator (IMS) device, a fragmentation or reaction device, and a mass analyser; applying voltages to the mass filter such that it simultaneously has multiple mass transmission windows that simultaneously transmit multiple respective precursor ion species to the IMS device whilst filtering out other precursor ion species; separating, in the IMS device, the precursor ion species that are simultaneously transmitted by the mass filter so as to provide different ones of the precursor ion species to the fragmentation or reaction device at different times; sequentially fragmenting or reacting the different precursor ion species in the fragmentation or reaction device so as to form fragment or product ions; detecting the fragment or product ions in the mass analyser; and associating detected fragment or product ions with their respective precursor ion species based on the times of detection of the fragment or product ions in the mass analyser.

As multiple precursor ion species are simultaneously transmitted (by the multiple mass transmission windows) and are then separated in the IMS device, precursor ion species of interest are able to be processed at a relatively high throughput rate and duty cycle, whilst still isolating each precursor ion species for fragmentation or reaction.

Providing the mass filter upstream of the IMS device reduces the ion current passing into the IMS device, which helps avoid space-charge effects within the IMS device. For example, the IMS device may have an ion accumulation region (e.g. ion trap) at its upstream end that receives ions from the mass filter and pulses the ions into a separation region in which the ions separate according to mobility. As the mass filter filters out ions, only selected ions of interest may pass into the ion accumulation region and so the space-charge capacity of the ion accumulation region is not wasted by ion species that are not of interest.

The provision of an IMS device downstream of a mass filter in this manner is somewhat counter-intuitive in that a mass filter is typically operated such that it only transmits a single ion species at any given time, and so it would generally be seen as unnecessary to separate the ions that are transmitted in an IMS device.

The method may comprise maintaining the separation between the precursor ion species, that is imparted by the IMS device, as the precursor ion species travel to and into the fragmentation or reaction device. The fragment or product ions may be urged downstream through the fragmentation or reaction device and to the mass analyser in a manner such that the fragment or product ions of different precursor ion species arrive at the mass analyser and are mass analysed at different, respective times.

The IMS device may have an ion accumulation region and an ion separation region, wherein the IMS device is controlled to accumulate the precursor ion species that are transmitted by the mass filter in the ion accumulation region and to then pulse the accumulated ions into the separation region such that the precursor ion species separate according to mobility so that different precursor ion species elute from the separation region at different times.

For example, the separation region may be a drift tube that contains a background gas therein and an electric field, such as a static DC electric field, may be maintained along the drift tube. The electric field may be arranged so as to urge ions in the downstream direction through the gas. Ions having different mobilities through the gas will therefore elute from the separation region at different times.

Alternatively, an electric potential, such as a DC potential, may be repeatedly travelled along the separation region in the downstream direction so as to urge ions downstream through the background gas as the electric potential passes the ions. Ions having different mobilities through the gas will be urged along the separation region by different amounts each time the potential travels along the separation region. As such, the ions become separated according to their mobility through the gas and elute from the separation region at different times.

The ions may be radially confined with the separation region of the IMS device, but are preferably free to exit the downstream end as they are separated, i.e. preferably there is no barrier preventing any of the precursor ions from exiting the downstream end of the separation region whilst they are being separated.

Alternatively, the IMS device may accumulate the precursor ion species that are transmitted by the mass filter in a trapping region that radially and axially confines the precursor ions. Opposing forces may then be applied to the precursor ions in opposing axial directions so as to separate the ions by mobility in the axial direction. For example, a DC electric field may be applied so as to generate a force on the ions in one axial direction and a gas flow may be provided in the other axial direction so as to generate a force on the ions. Alternatively to the gas flow, an electrical potential may be repeatedly travelled along the trapping region in said other axial direction so as to generate a force on the ions. The magnitude of one of the forces may be increased or decreased with time such that precursor ion species having different mobilities elute from the downstream end of the IMS device trapping region at different time. The ions may be caused to elute from the IMS device in order of low to high mobility, or high to low mobility, depending on which forces are applied in which direction.

The step of applying voltages to the mass filter applies voltages to the mass filter such that the mass filter simultaneously transmits ions having mass to charge ratios that are within at least first and second separate mass to charge ratio ranges, i.e. such that the mass filter simultaneously transmits ions having mass to charge ratios that are within at least first and second separate mass transmission windows. For the avoidance of doubt, when multiple mass transmission windows are applied to the mass filter, there is a range of mass to charge ratios between adjacent mass transmission windows that are not able to be transmitted by the mass filter. In other words, the mass transmission windows that are simultaneously applied have discrete, non-overlapping ranges of mass to charge ratios.

The mass filter may be a multipole mass filter, such as a quadrupole mass filter. The use of such a mass filter, e.g. rather than a mass selective ion trap, to transmit selected precursor ion species of interest avoids space-charge effects during the filtering and also provides a device that is faster to switch to transmitting different precursor ion species.

Ions are preferably not (axially) trapped within the mass filter, and are preferably not (axially) trapped within the spectrometer at any region upstream of the mass filter. In other words, the ions that are transmitted by the mass filter may be free to pass into, through and out of the mass filter without any axial trapping. This avoids space-charge effects that would otherwise negatively influence the analysis of the ions. Although the ions that are transmitted by the mass filter may be accumulated in the IMS device, this is after the mass filtering has been performed and so the ion current passing into the accumulation region is lower than prior to the mass filter.

The multipole mass filter may comprise a multipole rod set of electrodes, such as a quadrupole rod set of electrodes. Each of the rods in the rod set may or may not be axially segmented.

RF voltages may be applied to electrodes of the mass filter so as to radially confine ions within the mass filter, such that the ions travel along an axial path through the mass filter. An auxiliary voltage may be applied to at least some of the electrodes of the mass filter so as to create the mass transmission windows described herein. For example, the auxiliary voltage may be an AC dipolar or quadrupolar field that is applied to the electrodes so as to radially excite and filter out ions having mass to charge ratios that are outside of the mass transmission windows.

The mass filter may be an AC-only (e.g. RF-only) mass filter, i.e. not having DC voltages applied to it.

The number of mass transmission windows that are simultaneously present in the mass filter may be varied during a period whilst precursor ion species are substantially continually supplied to the mass filter.

The period of time that precursor ion species are substantially continually supplied to the mass filter may be the duration of a single experimental run. The number of mass transmission windows that are simultaneously present in the mass filter may therefore be varied during a single experimental run. In embodiments, a single experimental run may be considered to be the duration that a sample is substantially continuously supplied to the spectrometer.

At least two mass transmission windows may be simultaneously applied to the mass filter during a first duration of said period whilst precursor ion species are substantially continually supplied to the mass filter, wherein; (i) only a single mass transmission window is provided during a second, different duration of said period, and/or (ii) two or more mass transmission windows are simultaneously provided during a third duration of said period.

The first, second and third durations are different durations and may be non-overlapping durations.

The spectrometer may comprise a processor and electronic circuitry that automatically varies with time the amplitude and/or frequency of one or more voltages that are applied to the mass filter so as to vary the number of mass transmission windows that are simultaneously applied during said period.

Different mass transmission windows maybe applied to the mass filter at different respective times during a period, or said period, whilst precursor ion species are substantially continually supplied to the mass filter, such that different precursor ion species of interest are transmitted by the mass filter at said different respective times.

For the avoidance of doubt, by the term different mass transmission windows it is meant mass transmission windows having different ranges of mass to charge ratios.

At least two mass transmission windows may be simultaneously applied to the mass filter during one duration of the period whilst precursor ion species are substantially continually supplied to the mass filter; and at least one mass transmission window may applied to the mass filter during another, different duration of the period; where the mass to charge ratio range of each of said at least two mass transmission windows is different to the mass to charge ratio range of each of said at least one mass transmission window.

In order to change the mass transmission windows that are applied to the mass filter, the spectrometer may comprise a processor and electronic circuitry that varies the amplitude and/or frequency of one or more voltages that are applied to the mass filter with time. The amplitude and/or frequency may be scanned substantially continuously or stepped between discrete values such that the mass to charge ratio range(s) of the mass transmission window(s) is scanned substantially continuously or stepped between discrete values during said period.

The method may comprise performing a survey scan mode in which mass spectral data is obtained that is indicative of the intensities and mass to charge ratios of the ions being supplied to the mass filter; and subsequently selecting the mass to charge ratio ranges of the mass transmission windows that are simultaneously applied to the mass filter based on the intensities of the ions detected in the survey scan mode.

Each of the intensities in the mass spectral data (for a plurality of ion species) may be converted into a rate of charge passing out of the mass filter for the corresponding ion species. The step of selecting the mass to charge ratio ranges of the mass transmission windows that are simultaneously applied to the mass filter may comprise selecting windows so as to transmit ions (corresponding to those detected in the survey scan mode) that have a combined rate of charge passing out of the mass filter that is below a preselected threshold value. This enables, for example, to ensure that space-charge effects do not become problematic in downstream devices, such as the IMS device.

In the survey scan mode the mass filter may be operated as an ion guide, i.e. so as to substantially not mass filter ions transmitted to it. The fragmentation or reaction device may also be deactivated in this mode, such that the precursor ions transmitted to the mass filter are mass analysed so as to obtain the mass spectral data. Alternatively, the fragmentation or reaction device may be activated in the survey scan mode and the intensities of the fragment or product ions (which are related to the intensities of their precursor ions) may be used to select the mass transmission windows that are simultaneously applied to the mass filter.

The voltages that are applied to the mass filter may be selected such that, for at least one of the mass transmission windows and at any given time, the mass transmission window is configured to cause ions having a mass to charge ratio located at the centre of the window to transmitted by the mass filter with a relatively high transmission efficiency, and to cause ions having a mass to charge ratio that is located within the window and closer to an edge of the window to be transmitted by the mass filter with a lower transmission efficiency; and the method may comprise: selecting a mass to charge ratio corresponding to that of one of said precursor ion species to be transmitted by the mass filter; and applying said voltages to the mass filter such that said selected mass to charge ratio is located in the mass transmission window at a position that is off-centre or proximate an edge of the mass transmission window.

This effectively attenuates the selected precursor ion species which, for example, can help avoid space-charge effects downstream of the mass filter.

The voltages may be applied to the mass filter such that the transmission efficiency for the ions progressively drops for mass to charge ratios located progressively closer, respectively, to an edge of the window. As such, the position of the window can be chosen to achieve the desired level of attenuation for ions of the selected mass to charge ratio.

The mass to charge ratio ranges of the mass transmission windows that are simultaneously applied to the mass filter may be selected such that the different precursor ion species that are simultaneously transmitted by these mass transmission windows have average elution times from the IMS device that differ from each other by more than a pre-selected threshold value.

In other words, the different precursor ion species that are simultaneously transmitted by these mass transmission windows may enter an accumulation region of the IMS device and are then pulsed into a separation region of the IMS device at substantially the same time. These precursor ion species are then separated in the separation region and elute from the separation region at different elution times (relative to the time they were pulsed into the separation region), where the elution times differ from each other by more than the pre-selected threshold value.

The mass to charge ratio ranges of the mass transmission windows that are simultaneously applied to the mass filter may be selected such that the different precursor ion species that are simultaneously transmitted by these mass transmission windows elute from the IMS device over different, non-overlapping time periods.

The method may comprise: selecting a set of multiple precursor ion species as being precursor ion species of interest that are to be analysed during a period in which precursor ion species are substantially continually supplied to the mass filter; determining that the mass filter is to be provided with a first mass transmission window during said period for transmitting a first of the multiple precursor ion species of interest; determining a second of the multiple precursor ion species of interest that has the closest mass to charge ratio to the first precursor ion species of interest, whilst also having an elution time from the IMS device that differs from the elution time from the IMS device of the first precursor ion species of interest by more than a pre-selected threshold value; determining that the mass filter is to be provided with a second mass transmission window so as to be capable of transmitting the second precursor ion species of interest; and simultaneously providing the mass filter with the first and second mass transmission windows.

The pre-selected threshold value may be selected to be a value that ensures that the first precursor ion species of interest elutes from the IMS device over a different, non-overlapping time period to the second precursor ion species of interest.

The method may further comprise: determining a third of the multiple precursor ion species of interest that has the closest mass to charge ratio to the second precursor ion species of interest, whilst also having an elution time from the IMS device that differs from the elution time from the IMS device of each of the first and second precursor ion species of interest by more than a pre-selected threshold value; determining that the mass filter is to be provided with a third mass transmission window so as to be capable of transmitting the third precursor ion species of interest; and simultaneously providing the mass filter with the first, second and third mass transmission windows.

The pre-selected threshold value may be selected to be a value that ensures that the third precursor ion species of interest elutes from the IMS device over a different, non-overlapping time period to each of the first and second precursor ion species of interest.

The method may further comprise: determining a further one of the multiple precursor ion species of interest that has an elution time from the IMS device that differs from the elution time from the IMS device of each of the first and second precursor ion species of interest, and optionally also the third precursor ion species of interest, by less than a pre-selected threshold value; determining that the mass filter is to be provided with a further mass transmission window so as to be capable of transmitting said further one of the multiple precursor ion species of interest; and providing the mass filter with said further mass transmission window at a different time during said period, in which precursor ion species are substantially continually supplied to the mass filter, to when the first and second, and optionally third, mass transmission windows are applied.

The pre-selected threshold value may be selected to be a value that ensures that said further precursor ion species of interest elutes from the IMS device over a different, non-overlapping time period to the first and second, and optionally third, precursor ion species of interest.

The spectrometer may automatically perform steps comprising: (i) determining the different combinations of said multiple precursor ion species of interest that may be transmitted by the mass filter simultaneously, where all of the precursor ion species of interest in each of the combinations have elution times from the IMS device that differ from each other by more than a pre-selected threshold; (ii) selecting a plurality of said combinations that together include all of the multiple precursor ion species of interest; and (iii) applying different mass transmission windows to the mass filter at different times such that different combinations of said plurality of combinations of precursor ion species of interest are transmitted by the mass filter at different respective times until all of the multiple precursor ion species of interest have been transmitted by the mass filter.

The pre-selected threshold value may be selected to be a value that ensures that the precursor ion species of interest in each of the combinations elute from the IMS device over different, non-overlapping time periods.

Step (iii) may comprise the spectrometer automatically selecting a time sequence in which the mass transmission windows are applied to the mass filter, including which mass transmission windows are applied simultaneously, so as to optimise the overall duty cycle for the transmission of the precursor ion species of interest; and then applying said sequence to the mass filter.

Any given fragment or product ion species detected at the mass analyser may be correlated to its respective precursor ion species using the time that the fragment or product ion species was detected by the mass analyser and knowledge of the times that precursor ion species are known to have, or estimated to have, eluted from the IMS device. For example, the times that precursor ion species elute from the IMS device may be experimentally determined, such as in a survey scan.

Alternatively, the times that precursor ion species elute from the IMS device may be theoretically estimated. For example, the elution times of the precursor ion species of interest from the IMS device may be predicted based on a relationship between the mass to charge ratios of the precursor ion species of interest and the mobilities of those ions.

Although embodiments have been described in which the precursor ion species are separated by mobility, it is alternatively contemplated that the precursor ion species may be separated by mass to charge ratio.

Accordingly, from a second aspect the present invention also provides a method of mass spectrometry comprising: providing a mass spectrometer comprising a mass filter, a mass to charge ratio separator device, a fragmentation or reaction device, and a mass analyser; applying voltages to the mass filter such that it simultaneously has multiple mass transmission windows that simultaneously transmit multiple respective precursor ion species to the separator device whilst filtering out other precursor ion species; separating, in the separator device, the precursor ion species that are simultaneously transmitted by the mass filter so as to provide different ones of the precursor ion species to the fragmentation or reaction device at different times; sequentially fragmenting or reacting the different precursor ion species in the fragmentation or reaction device so as to form fragment or product ions; detecting the fragment or product ions in the mass analyser; and associating detected fragment or product ions with their respective precursor ion species based on the times of detection of the fragment or product ions in the mass analyser.

As multiple precursor ion species are simultaneously transmitted (by the multiple mass transmission windows) and are then separated in the separator device, precursor ion species of interest are able to be processed at a relatively high throughput rate and duty cycle, whilst still isolating each precursor ion species for fragmentation or reaction. Providing the mass filter upstream of the separator device reduces the ion current passing into the separator device, which helps avoid space-charge effects within the separator device. The provision of an separator device downstream of a mass filter in this manner is somewhat counter-intuitive in that a mass filter is typically operated such that it only transmits a single ion species at any given time, and so it would generally be seen as unnecessary to separate the ions that are transmitted in an separator device.

The method according to the second aspect of the invention may have any one, or any combination of any two or more, of the features that have been described herein in relation to the first aspect of the present invention, except that the IMS device of the first aspect is replaced by the mass to charge ratio separator device of the second aspect.

For example, the method may comprise maintaining the separation between the precursor ion species, that is imparted by the separator device, as the precursor ion species travel to and into the fragmentation or reaction device. The fragment or product ions may be urged downstream through the fragmentation or reaction device and to the mass analyser in a manner such that the fragment or product ions of different precursor ion species arrive at the mass analyser and are mass analysed at different, respective times.

The mass filter may be a multipole mass filter, such as a quadrupole mass filter.

The use of such a mass filter, e.g. rather than a mass selective ion trap, to transmit selected precursor ion species of interest avoids space-charge effects during the filtering and also provides a device that is faster to switch to transmitting different precursor ion species.

Ions are preferably not (axially) trapped within the mass filter, and are preferably not (axially) trapped within the spectrometer at any region upstream of the mass filter. In other words, the ions that are transmitted by the mass filter may be free to pass into, through and out of the mass filter without any axial trapping. This avoids space-charge effects that would otherwise negatively influence the analysis of the ions. Although the ions that are transmitted by the mass filter may be accumulated in the separation device, this is after the mass filtering has been performed and so the ion current passing into the accumulation region is lower than prior to the mass filter.

The separator device may comprise a non-mass selective ion trap and an ion separation region, wherein the separator device is controlled to accumulate the precursor ion species that are simultaneously transmitted by the mass filter in the ion trap, to pulse the accumulated ions into the separation region substantially simultaneously, and to separate the precursor ion species according to mass to charge ratio within the separation region such that different precursor ion species elute from the separation region at different times.

An electric potential, such as a DC potential, may be repeatedly travelled along the separation region in the downstream direction. The amplitude and speed of the electric potential, as well as the gas pressure and length of the separation region, may be selected such that the electric potential causes ions to become separated according to their mass to charge ratio and elute from the separation region at different times.

Alternatively, the separation region may be a region of sufficiently low pressure and long length such that when the ions are pulsed into the separation region by the ion trap they separate according to mass to charge ratio as they pass along the separation region, e.g. the separation region may be a time of flight region. Ions having different mass to charge ratios will therefore elute from the separation region at different times.

The ions may be radially confined with the separation region, but are preferably free to exit the downstream end as they are separated, i.e. preferably there is no barrier preventing any of the precursor ions from exiting the downstream end of the separation region whilst they are being separated.

All of the precursor ions may be free to exit the downstream end of separator device whilst the ions are being separated by mass to charge ratio; and/or the precursor ions may pass through and exit the separator device without having been urged in the downstream direction so as to be forced over a potential barrier.

The mass to charge ratio ranges of the mass transmission windows that are simultaneously applied to the mass filter may be selected such that the different precursor ion species that are simultaneously transmitted by these mass transmission windows have average elution times from the separator device that differ from each other by more than a pre-selected threshold value.

In other words, the different precursor ion species that are simultaneously transmitted by these mass transmission windows may enter an accumulation region of the separator device and are then pulsed into a separation region of the separator device at substantially the same time. These precursor ion species are then separated in the separation region and elute from the separation region at different elution times (relative to the time they were pulsed into the separation region), where the elution times differ from each other by more than the pre-selected threshold value.

The mass to charge ratio ranges of the mass transmission windows that are simultaneously applied to the mass filter may be selected such that the different precursor ion species that are simultaneously transmitted by these mass transmission windows elute from the separator device over different, non-overlapping time periods.

The method may comprise: selecting a set of multiple precursor ion species as being precursor ion species of interest that are to be analysed during a period in which precursor ion species are substantially continually supplied to the mass filter; determining that the mass filter is to be provided with a first mass transmission window during said period for transmitting a first of the multiple precursor ion species of interest; determining a second of the multiple precursor ion species of interest that has the closest mass to charge ratio to the first precursor ion species of interest, whilst also having an elution time from the separator device that differs from the elution time from the separator device of the first precursor ion species of interest by more than a pre-selected threshold value; determining that the mass filter is to be provided with a second mass transmission window so as to be capable of transmitting the second precursor ion species of interest; and simultaneously providing the mass filter with the first and second mass transmission windows.

The pre-selected threshold value may be selected to be a value that ensures that the first precursor ion species of interest elutes from the separator device over a different, non-overlapping time period to the second precursor ion species of interest.

The method may further comprise: determining a third of the multiple precursor ion species of interest that has the closest mass to charge ratio to the second precursor ion species of interest, whilst also having an elution time from the separator device that differs from the elution time from the separator device of each of the first and second precursor ion species of interest by more than a pre-selected threshold value; determining that the mass filter is to be provided with a third mass transmission window so as to be capable of transmitting the third precursor ion species of interest; and simultaneously providing the mass filter with the first, second and third mass transmission windows. The pre-selected threshold value may be selected to be a value that ensures that the third precursor ion species of interest elutes from the separator device over a different, non-overlapping time period to each of the first and second precursor ion species of interest.

The method may further comprise: determining a further one of the multiple precursor ion species of interest that has an elution time from the separator device that differs from the elution time from the separator device of each of the first and second precursor ion species of interest by less than a pre-selected threshold value; determining that the mass filter is to be provided with a further mass transmission window so as to be capable of transmitting said further one of the multiple precursor ion species of interest; and providing the mass filter with said further mass transmission window at a different time during said period, in which precursor ion species are substantially continually supplied to the mass filter, to when the first and second mass transmission windows are applied.

The pre-selected threshold value may be selected to be a value that ensures that said further precursor ion species of interest elutes from the separator device over a different, non-overlapping time period to the first and second precursor ion species of interest.

The spectrometer may automatically performs steps comprising: (i) determining the different combinations of said multiple precursor ion species of interest that may be transmitted by the mass filter simultaneously, where all of the precursor ion species of interest in each of the combinations have elution times from the separator device that differ from each other by more than a pre-selected threshold; (ii) selecting a plurality of said combinations that together include all of the multiple precursor ion species of interest; and (iii) applying different mass transmission windows to the mass filter at different times such that different combinations of said plurality of combinations of precursor ion species of interest are transmitted by the mass filter at different respective times until all of the multiple precursor ion species of interest have been transmitted by the mass filter.

The pre-selected threshold value may be selected to be a value that ensures that the precursor ion species of interest in each of the combinations elute from the separator device over different, non-overlapping time periods.

Step (iii) may comprise the spectrometer automatically selecting a time sequence in which the mass transmission windows are applied to the mass filter, including which mass transmission windows are applied simultaneously, so as to optimise the overall duty cycle for the transmission of the precursor ion species of interest; and then applying said sequence to the mass filter.

Any given fragment or product ion species detected at the mass analyser may be correlated to its respective precursor ion species using the time that the fragment or product ion species was detected by the mass analyser and knowledge of the times that precursor ion species are known to have, or estimated to have, eluted from the separator device. For example, the times that precursor ion species elute from the separator device may be experimentally determined, such as in a survey scan. Alternatively, the times that precursor ion species elute from the separator device may be theoretically estimated.

The separation device may be maintained at a pressure of ≥5 mbar. Such a relatively high pressure separation device enables it to be operated as a mass to charge ratio and/or mobility separator, depending on the electric fields that are generated by the separation device. Accordingly, in a first mode voltages may be applied to the separation device so as to urge ions through the separation device such that they separate according to their mass to charge ratio. In a second mode voltages may be applied to the separation device differently so as to urge ions through the separation device such that they separate according to their mobility (or according to a combination of their mobility and mass to charge ratio).

The separation device may be maintained at, for example, a pressure between 0.5 and 10 mbar.

The present invention also provides a mass spectrometer having one or more processors and electronic circuitry configured to perform any of the methods described herein.

Accordingly, the present invention provides a mass spectrometer comprising: a mass filter; a separator device, such as an ion mobility separator (IMS) device; a fragmentation or reaction device; a mass analyser; and a processor and control circuitry configured to control the spectrometer to: apply voltages to the mass filter such that it simultaneously has multiple mass transmission windows for simultaneously transmitting multiple respective precursor ion species to the separator device whilst filtering out other precursor ion species; separate, in the separator device, the precursor ion species that are simultaneously transmitted by the mass filter so as to provide different ones of the precursor ion species to the fragmentation or reaction device at different times; sequentially fragment or react the different precursor ion species in the fragmentation or reaction device so as to form fragment or product ions; detect the fragment or product ions in the mass analyser; and associate detected fragment or product ions with their respective precursor ion species based on the times of detection of the fragment or product ions in the mass analyser.

Embodiments have been described in which the mass filter only transmits ions that have mass to charge ratios within the mass transmission windows and filters out substantially all ions having mass to charge ratios outside of the mass transmission windows. However, it is alternatively contemplated that the mass filter may only partially attenuate ions having mass to charge ratios that are outside of the mass transmission windows described, rather than fully attenuate these ions.

In other words, voltages may be applied to the mass filter such that it simultaneously transmits ions having mass to charge ratios in a first set of mass transmission windows, whilst also simultaneously attenuating and transmitting ions having mass to charge ratios in a second set of mass transmission windows. The ions transmitted by the second set of mass transmission windows are attenuated to a greater degree than those transmitted by the first set of mass transmission windows, i.e. the proportion of ions transmitted by the second set of mass transmission windows is lower than the proportion of ions transmitted by the first set of mass transmission windows. For example, the ions transmitted by the first set of mass transmission windows may substantially not be attenuated by the mass filter.

Accordingly, from a third aspect the invention provides a method of mass spectrometry comprising: providing a mass spectrometer comprising a mass filter, a separator device, a fragmentation or reaction device, and a mass analyser; applying voltages to the mass filter such that it simultaneously transmits precursor ions having mass to charge ratios in a first set of mass transmission windows, whilst also simultaneously attenuating and transmitting precursor ions having mass to charge ratios in a second set of mass transmission windows; separating, in the separator device, precursor ion species that are simultaneously transmitted by the mass filter so as to provide different ones of the precursor ion species to the fragmentation or reaction device at different times; sequentially fragmenting or reacting the different precursor ion species in the fragmentation or reaction device so as to form fragment or product ions; detecting the fragment or product ions in the mass analyser; and associating detected fragment or product ions with their respective precursor ion species based on the times of detection of the fragment or product ions in the mass analyser.

The method according to the third aspect of the invention may have any one, or any combination of any two or more, of the features that have been described herein in relation to the first or second aspects of the present invention, except that the mass filter may only partially attenuate ions having mass to charge ratios that are outside of the mass transmission windows described in relation to the first and second aspects, rather than fully attenuate these ions. In other words, the mass transmission windows described in the first and second aspects may correspond to the first set of mass transmission windows described in the third aspect, whereas mass ranges outside of the mass transmission windows described in the first and second aspects may correspond to the second set of mass transmission windows described in the third aspect.

The third aspect of the invention also provides a mass spectrometer comprising: a mass filter; a separator device, such as an ion mobility separator (IMS) device or mass to charge ratio separator; a fragmentation or reaction device; a mass analyser; and a processor and control circuitry configured to control the spectrometer to: apply voltages to the mass filter such that it simultaneously transmits precursor ions having mass to charge ratios in a first set of mass transmission windows, whilst also simultaneously attenuating and transmitting precursor ions having mass to charge ratios in a second set of mass transmission windows; separate, in the separator device, precursor ion species that are simultaneously transmitted by the mass filter so as to provide different ones of the precursor ion species to the fragmentation or reaction device at different times; sequentially fragment or react the different precursor ion species in the fragmentation or reaction device so as to form fragment or product ions; detect the fragment or product ions in the mass analyser; and associate detected fragment or product ions with their respective precursor ion species based on the times of detection of the fragment or product ions in the mass analyser.

### BRIEF DESCRIPTION OF THE DRAWINGS

Various embodiments of the present invention will now be described, by way of example only, and with reference to the accompanying drawings in which:

FIG. 1 shows a schematic of a mass spectrometer according to an embodiment of the present invention;

FIG. 2 shows a schematic of a mass filter, which may be used in embodiments of the present invention;

FIG. 3 shows an example of a notched broadband frequency signal which may be applied to the mass filter; and

FIG. 4 illustrates an example of how the mass analysis times of fragment or product ions are related to their precursor ions.

### DETAILED DESCRIPTION

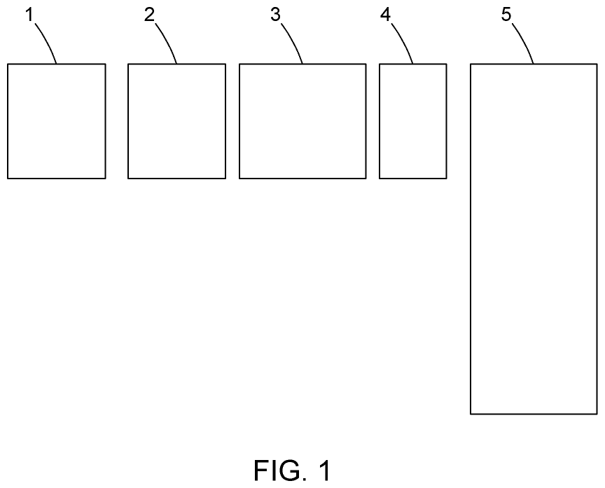

FIG. 1 shows a schematic of a mass spectrometer according to an embodiment of the present invention. The spectrometer comprises an ion source 1, a mass filter 2, an ion mobility separator (IMS) 3, a fragmentation or reaction device 4, and a mass analyser 5.

In operation, a sample to be analysed is delivered to an ion source 1. A sample separation device (not shown) may be provided upstream of the ion source for separating the analytes in the sample and sequentially delivering the separated analytes to the ion source. For example, the sample separation device may be a chromatographic separator, such as a liquid chromatography device. The sample may be continually supplied to the spectrometer whilst it performs an experimental run, as will be described below.

The sample arrives at the ion source 1 and is ionised so as to generate precursor ions, which are then transmitted to the mass filter 2. Voltages are applied to the mass filter such that the mass filter is only able to transmit ions having certain mass to charge ratios at any given time. The ions that are transmitted by the mass filter pass to the IMS device 3, whereas the ions that are not transmitted by the mass filter are filtered out and may be discarded.

The mass filter 2 is operated such that at any given time it is capable of transmitting ions having mass to charge ratios that falls within one or more mass transmission window. The mass filter is operated so as to be capable of transmitting ions having mass to charge ratios that fall within two or more distinct mass to charge ratio transmission windows during at least part of the experimental run, and to filter out the other ions. As such, during at least part of the experimental run, the mass filter is capable of simultaneously transmitting multiple precursor ion species to the IMS device 3.

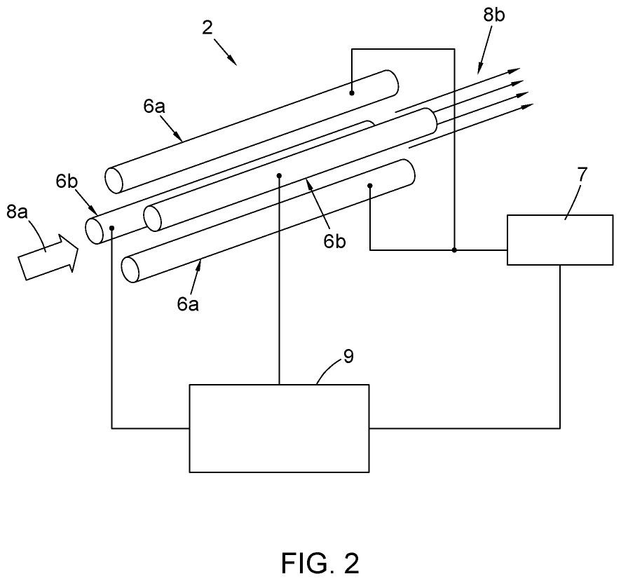

FIG. 2 shows a schematic of a mass filter 2, which may be used in embodiments of the present invention. The mass filter comprises a quadrupole rod set, which may comprise four parallel rods 6a,6b, although other multipole devices may be used. The rods may be connected to a two phase AC or RF voltage supply 7. Adjacent rods may be arranged so as to have opposite phases of an AC or RF voltage applied to them and diametrically opposed rods may be arranged so as to have the same phase of an AC or RF voltage applied to them. Ions 8a are transmitted from the ion source 1 to the mas filter.

The AC or RF voltage applied to the rods creates a radial pseudo-potential well which acts to radially confine ions within the mass filter 2. An auxiliary voltage 9 is applied to at least some of the electrodes so as to create the multiple mass transmission windows. For example, a notched broadband frequency signal may be applied to at least some of the electrodes, e.g. to an opposed pair of rods 6a,6b. The notched broadband frequency signal may be an auxiliary RF dipolar or quadrupolar field. As will be described in more detail below, the application of a notched broadband frequency signal to the rods causes ions having certain mass to charge ratios to be resonantly excited and radially ejected from the mass filter. The strength of the resonant excitation and radial movement of the undesired ions is sufficient to overcome the effect of the radial pseudo-potential well generated by the applied AC or RF voltage which otherwise seeks to radially confine ions within the mass filter.

The notches provided in the otherwise broadband frequency signal are arranged such that there are some frequencies which are absent from the broadband frequency signal that is applied to the rods 6a,6b. Ions 8b having resonance or first harmonic frequencies which substantially correspond with the absent frequencies in the applied broadband frequency signal will not therefore be resonantly excited by the applied broadband frequency signal. Accordingly, these ions will not be radially ejected from the mass filter 2. Consequently, these ions will therefore be substantially unaffected by the application of the broadband frequency signal to the rods and will be onwardly transmitted by the mass filter 2. According to a less preferred embodiment the notched broadband frequency signal which is applied to the rods may include relatively low amplitude frequency components which may resonantly excite analyte ions of interest but only to a relatively small or minor degree. The amplitude of these frequency components may be kept relatively low and hence the ions of interest are not sufficiently resonantly excited such that they are able to overcome the radially confining action of the radial pseudo-potential well resulting from the applied AC or RF voltage.

It will therefore be appreciated that each notch in the broadband waveform corresponds to a mass transmission window of the mass filter.

The broadband waveform which is applied to a pair of rods 6a,6b may be generated by initially providing a broadband frequency signal and then removing two or more discrete ranges of frequency components from the broadband frequency signal. Those frequencies which are removed from the broadband frequency signal may correspond with the resonance or first harmonic frequencies of ions of interest which are desired to be onwardly transmitted by the mass filter 2.

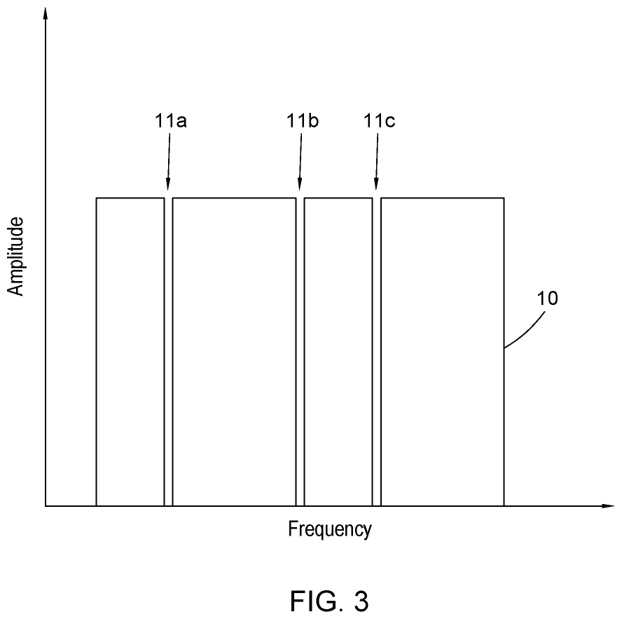

FIG. 3 shows an example of a notched broadband frequency signal 10 which may be applied to the mass filter 2. The notched broadband frequency signal is shown having three frequency notches 11a, 11b, 11c corresponding to the resonant or first harmonic frequency of three species of analyte ions which are desired to be onwardly transmitted by the mass filter. In other words, the three frequency notches 11a, 11b, 11c correspond to three, respective mass transmission windows of the mass filter. The range of the broadband frequency signal 10 may be sufficiently wide such that all ions present in an ion beam 8a received by the mass filter 2 will be resonantly excited and radially ejected except for the ions of interest that have resonance frequencies which correspond with one of the frequency notches 11a, 11b, 11c. Although the example shown simultaneously applies three frequency notches to the mass filter (i.e. the mass filter simultaneously has three mass transmission windows), it will be appreciated that any number of frequency notches (i.e. any number of mass transmission windows) may be simultaneously applied to the mass filter in accordance with the teachings herein.

Alternatively, the required waveform may be determined by adjusting the frequencies, amplitudes and phases of a set of discrete frequencies in-silico until the desired mass transmission characteristics are obtained. This search may involving optimisation of an objective function that measures the quality of the waveform produced.

The number of mass transmission windows 11a, 11b, 11c that are simultaneously present in the mass filter 2 may be varied during the single experimental run. For example, two mass transmission windows may be simultaneously provided for a first duration during the experimental run, whereas only one mass transmission window may be provided during another duration of the experimental run. Additionally, or alternatively, more than two mass transmission windows may be simultaneously provided for a different duration during the experimental run. The spectrometer may comprise a processor and electronic circuitry that varies the amplitude and/or frequency of one or more voltages that are applied to the mass filter with time so as to vary the number of mass transmission windows that are simultaneously applied during the experimental run.

The mass to charge ratio range of at least one, at least some, or all, of the mass transmission windows may be varied during the experimental run such that different precursor ion species of interest are transmitted by the mass filter at different times during the experimental run. For example, the width of the mass transmission window may remain constant, but the values of mass to charge ratios encompassed by the mass transmission window may be varied during the experimental run such that different precursor ion species are able to be transmitted by the mass filter at different times. In order to vary the mass transmission window(s) in this manner, the spectrometer may comprise a processor and electronic circuitry that varies the amplitude and/or frequency of one or more voltages that are applied to the mass filter with time. The amplitude and/or frequency may be scanned substantially continuously or stepped between discrete values such that the mass to charge ratio range(s) of the mass transmission window(s) is scanned substantially continuously or stepped between discrete values during the single experimental run.

Examples of how the mass transmission windows may be varied during the experimental run, so as to transmit different precursor ion species at different times, are described further below.

As described above, the precursor ions 8a that are transmitted by the mass filter 2 enter the IMS device 3. The IMS device is configured to accumulate the precursor ions and then separate them according to their mobility. For example, the IMS device may have an ion accumulation region and an ion separation region. The IMS device is configured to accumulate precursor ions that are transmitted by the mass filter in the accumulation region and to then perform a separation cycle in which the accumulated ions are pulsed from the accumulation region into the separation region such that the ions are separated according to their mobility through the separation region, so as to cause ions having different mobilities to elute from the separation region at different times. For example, the separation region may be a drift tube that contains a background gas therein and an electric field, such as a static DC electric field, may be maintained along the drift tube. The electric field may be arranged so as to urge ions in the downstream direction through the gas. Ions having different mobilities through the gas will therefore elute from the separation region at different times. Alternatively, an electric potential, such as a DC potential waveform, may be repeatedly travelled along the separation region in the downstream direction so as to urge ions downstream through the background gas as the electric potential waveform passes the ions. Ions having different mobilities through the gas will be urged along the separation region by different amounts each time they are overtaken by the waveform. As such, the ions become separated according to their mobility through the gas and elute from the separation region at different times.

The separation cycle that comprises pulsing and separating ions may be repeated during the single experimental run. For example, the IMS device 3 may be configured to perform multiple separation cycles whilst the mass to charge ratio ranges of the mass transmission windows are held constant. Alternatively, the IMS device may be configured to perform only a single separation cycle whilst any given mass transmission window is held constant.

Ions are preferably not (axially) trapped within the mass filter, and are preferably not (axially) trapped within the spectrometer at any region upstream of the mass filter. In other words, the ions that are transmitted by the mass filter may be free to pass into, through and out of the mass filter without any axial trapping. This avoids space-charge effects that would otherwise negatively influence the analysis of the ions. Although the ions that are transmitted by the mass filter may be accumulated in the IMS device 3, this is after the mass filtering has been performed and so the ion current passing into the accumulation region is lower than prior to the mass filter.

The precursor ions that elute from the IMS device 3 pass into the fragmentation or reaction region 4 and are fragmented or reacted therein so as to form fragment or product ions. For example, the precursor ions may be fragmented in the fragmentation region by collision induced dissociation (CID), electron capture dissociation (ECD), electron transfer dissociation (ETD), or any other type of fragmentation technique so as to form fragment, ions, i.e. daughter ions. Alternatively, the precursor ions may be reacted in the reaction region with reagent ions or neutral reagent molecules so as to form product ions. The fragment or product ions that are generated in the fragmentation or reaction device, optionally along with any unfragmented or unreacted precursor ions, exit the fragmentation or reaction device and pass into the mass analyser 5 so as to be mass analysed.

The ions are urged through the spectrometer such that the separation imparted to the precursor ions by the IMS device 3 is maintained between those ions as they travel to the fragmentation or reaction device 4, and also such that the different sets of fragment or product ions that are generated for the different respective precursor ion species remain separated from each other as they travel downstream through the fragmentation or reaction device and to the mass analyser 5. In other words, fragment or product ions that are derived from a precursor ion species that elutes from the IMS device at a first time will arrive at and be mass analysed by the mass analyser at an earlier time than the fragment or product ions that are derived from a precursor ion species that elutes from the IMS device at a second, later time. More specifically, a first precursor ion species that elutes from the IMS device at a first elution time, will arrive at the fragmentation or reaction device at a relatively early time and will be fragmented or reacted thereby. The resulting fragment or product ions will then arrive at the mass analyser at a first mass analysis time. In contrast, a second precursor ion species that elutes from the IMS device at a second, later elution time, will arrive at the fragmentation or reaction device at a relatively later time and will be fragmented or reacted thereby. The resulting fragment or product ions will then arrive at the mass analyser at a second, later mass analysis time.

The mass analyser 5 receives ions from each separation cycle, and/or fragment or product ions derived therefrom, over a time period. The mass analyser is controlled to repeatedly or continuously mass analyse ions during this time period. As such, the mass analyser is capable of mass analysing fragment or product ions that are derived from multiple different precursor ion species that are separated within each separation cycle of the IMS device 3. For example, the mass analyser may be a Time of Flight mass analyser that comprises an ion accelerator that repeatedly pulses ions into a time or flight region towards a detector, and determines the mass to charge ratios of the ions based on their time of flight from the ion accelerator to the detector.

The mass analyser 5 may record the mass to charge ratios of the fragment or product ions along with their respective times of detection. This may be used to associate the fragment or product ions detected with their respective precursor ions. In this respect, the time that a fragment or product ions is detected by the mass analyser is related to the time at which its respective precursor ion species eluted from the IMS device 3, since the elution time from the IMS device determines the time that the precursor ion species enters the fragmentation or reaction device 4 and therefore the time that the fragment or product ions are generated and mass analysed. Any given fragment or product ion species detected at the mass analyser may therefore be correlated to its respective precursor ion species using the time that the fragment or product ion species was detected by the mass analyser and knowledge of the times that precursor ion species are known to have, or estimated to have, eluted from the IMS device. For example, the times that precursor ion species elute from the IMS device may be determined in a survey scan or may be theoretically estimated, as described below.

As described herein, the mass filter 2 is controlled so as to have mass transmission windows that correspond to the mass to charge ratios of the precursor ion species of interest. As described above, the mass filter is operated so as to simultaneously have at least two different mass transmission windows, at least during a part of the experimental run. However, it is also contemplated that the mass filter may have only a single mass transmission window during a part of the experimental run, e.g. if it is desired to transmit only a single precursor ion species at that time.

The precursor ions of interest that are to be selected for transmission by the mass filter 2 may be determined by analysing the sample with the spectrometer in a survey scan, prior to analysing the sample in the experimental run as described hereinabove, i.e. as part of a data dependent acquisition (DDA) experiment. For example, the analytes in the sample may be ionised and the resulting precursor ions detected by the mass analyser 5, such that the precursor ion species of interest can be selected from the detected precursor ion species. The mass filter may be operated as an ion guide during the survey scan, i.e. so as to be capable of transmitting a wide range of mass to charge ratios rather than operating as a mass filter. Also, the fragmentation or reaction device 4 may be operated such that substantially no fragmentation or reaction of the precursor ions occurs in the survey scan. It is also contemplated that the IMS device 3 may not separate the ions by mobility during the survey scan.

However, in alternative embodiments, the IMS device 3 is operated so as to separate the precursor ion species in the survey scan. This may be used to obtain data for use in correlating fragment or product ions detected by the mass analyser (in the non-survey scan mode described above) with their respective precursor ion species. According to these embodiments, in the survey scan the mass analyser 5 may record the mass to charge ratios of the precursor ion species that are detected along with their respective times of detection. The times of detection are related to the elution times of the precursor ions from the IMS device and hence are related to the times that these ions pass to the fragmentation or reaction device 4. As such, the times of detection of the precursor ion species in the survey scan are related to the times that their respective fragment or product ions will be generated and detected at the mass analyser in the non-survey scan mode. The times of detection of the fragment or product ions in the non-survey scan mode may therefore be used to assign fragment or product ion species to their respective precursor ion species.

Even if the IMS device 3 is not operated to separate ions during the survey scan, the times of detection of the fragment or product ions in the non-survey scan mode may still be used to assign fragment or product ion species to their respective precursor ion species. For example, the elution times of the precursor ion species of interest from the IMS device (in the non-survey scan mode) may be predicted based on a relationship between the mass to charge ratios and charge states of the precursor ion species of interest and the mobilities of those ions. These elution times are related to the times that the precursor ion species pass to the fragmentation or reaction device 4 and hence to the times that their respective fragment or product ions will be generated and detected at the mass analyser 5. As such, the times of detection of the fragment or product ions (in the non-survey scan mode) and the predicted elution times of the precursor ion species may be used to assign fragment or product ion species to their respective precursor ion species. The presence of unfragmented precursor ions in the MSMS data can also provide direct evidence for the precursor mass assignment.

Alternatively to performing a DDA technique, a targeted analysis may be performed in which the precursor ion species of interest are decided or known in advance of the experimental run, without performing a survey scan. In this event, the mass to charge ratio ranges of the mass transmission windows are selected such that the precursor ions of interest are transmitted. As described herein, different precursor ions of interest may be transmitted by the mass filter 2 at different times by varying the mass to charge ratio ranges of the mass transmission windows with time.

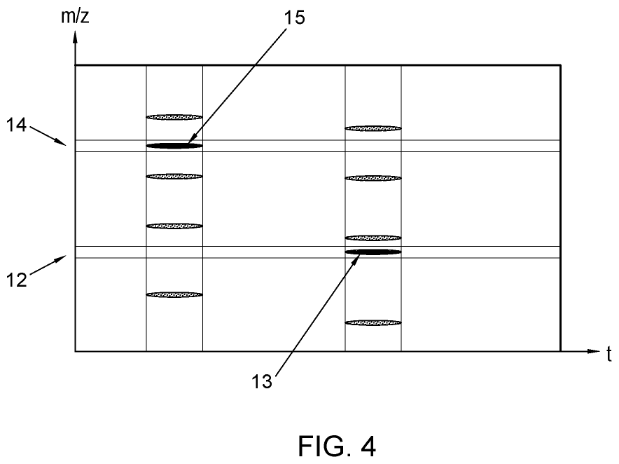

FIG. 4 illustrates an example of how the mass analysis times of fragment or product ions are related to their precursor ions. The plot shows the mass to charge ratios of the ions as a function of time of detection at the mass analyser. In this example the mass filter 2 is set so as to have a first mass transmission window 12 for transmitting a first, relatively low mass to charge ratio precursor ion species 13 and to simultaneously have a second mass transmission window 14 transmitting a second, higher mass to charge ratio precursor ion species 15. The first and second precursor ion species simultaneously enter the accumulation region of the IMS device 3 and are then pulsed together into the separation region such that they become separated by ion mobility and elute from the IMS device at different times. This is represented by the spacing of the precursor ions 13,15 along the x-axis. The first precursor ion species 13 elutes from the IMS device at a first time and enters the fragmentation or reaction device 4 so as to generate first fragment or product ions, which are illustrated by the ovals arranged vertically above and below precursor ion species 13. The first fragment or product ions are then transmitted downstream to the mass analyser 5. The second precursor ion species 15 elutes from the IMS device at a second, different time and enters the fragmentation or reaction device so as to generate second fragment or product ions, which are illustrated by the ovals arranged vertically above and below precursor ion species 15. The second fragment or product ions are then transmitted downstream to the mass analyser 5. The separation imparted between the precursor ions 13, 15 by the IMS device is maintained between their respective fragment or product ions. As such, even though the mass filter 2 transmits different precursor ion species simultaneously, their first and second sets of fragment or product ions are still able to be correlated to their respective precursor ion species. This enables the spectrometer to be operated with a duty cycle that is double that of an experiment in which a single precursor ion species is isolated at a time.

As described herein, the amplitude and/or frequency of one or more voltages that are applied to the mass filter 2 may be varied such that the mass to charge ratio ranges of the mass transmission windows varies with time during the single experimental run. For example, for a first duration during the experimental run the mass filter may simultaneously provide at least first and second mass transmission windows, whereas during a second, subsequent duration during the experimental run the mass filter may simultaneously provide at least a third and fourth mass transmission window, where each of the first and second mass transmission windows has a different mass range to the third and fourth mass transmission windows. Alternatively to the second duration, or additionally, for another duration during the experimental run the mass filter may provide at least one other mass transmission window, where said other mass transmission window is different to said first and second mass transmission windows (and different to the third and fourth mass transmission windows if they have been performed).

In order to ensure sufficient time-based sampling of eluting precursor ions (e.g. particularly in quantitative chromatographic experiments where a minimum number of sampling points across a chromatographic peak may be required), it may be beneficial to alternate between several different sets of mass transmission windows. For example, in the above example, in a third duration the mass filter may be configured in the same way that it was configured during the first duration, and in a fourth duration the mass filter may be configured in the same way that it was configured during the second duration. This example (i.e. alternating between two configurations) can obviously be extended to alternating between three or more mass filter configurations, each having any number of mass transmission windows.

The mass ranges of the mass to charge ratio windows that are simultaneously provided by the mass filter 2 are selected so as to each be capable of transmitting a precursor ion species of interest. The mass ranges of these windows are also be selected such that the different precursor ion species that are simultaneously transmitted have sufficiently different mobilities, e.g. such that the different precursor ion species have average mobilities that differ by more than a threshold value. For example, the mass ranges of the windows may be selected such that the different precursor ion species that are simultaneously transmitted will elute from the IMS device 3 at different times (e.g. over non-overlapping time periods). The mass ranges of these windows may also be selected to be separated from each other by a relatively small range of mass to charge ratios, e.g. to be separated by the minimum range of mass to charge ratios that fulfils the above conditions of transmitting precursor ion species of interest that have different elution times from the IMS device.

If the survey data scan operates the IMS device 3 so as to separate the precursor ions, then the elution times of the precursors may be determined from the survey data and used in the above described process to determine the mass ranges of the windows that should be provided simultaneously. Otherwise, the elution times may be predicted, as described above, and used to determine the mass ranges of the windows that should be provided simultaneously.

As it is known which precursor ion species of interest are desired to be analysed, and the elution times of these ions during a separation cycle is known or predicted, then the mass ranges of the mass transmission windows that are provided during the experimental run may be chosen so as to provide a relatively high overall duty cycle.

For example, it may be desired to analyse a plurality of precursor ion species of interest, e.g. species A, B, C, D, E where these species have progressively increasing mass to charge ratios. It may be determined that the mass filter 2 should be provided with a first mass window so as to be capable of transmitting a first of the species of interest, such as species A having the lowest mass to charge ratio. The other species of interest B, C, D, E may then be examined to determine which of the species, if any, that has the closest mass to charge ratio to the first species A whilst having said sufficiently different elution time from the IMS device 3 to species A. For example, species C may be determined to fulfil these conditions. As such, it may be determined that the mass filter should be simultaneously provided with first and second mass windows that are capable of transmitting species A and C respectively. The remaining species of interest B, D, E may then be examined to determine which of the species, if any, that has the closest mass to charge ratio to species C whilst having said sufficiently different elution time from the IMS device to species A and C. If it is determined that none of the remaining species of interest fulfils this condition then the mass filter is provided with only the first and second mass transmission windows for species A and C during a first duration of the experimental run. On the other hand, it may be determined that one of the remaining species of interest, for example species D, has the closest mass to charge ratio to species C whilst having said sufficiently different elution time from the IMS device to species A and C. As such, it may be determined that the mass filter should be simultaneously provided with first, second and third mass transmission windows that are capable of transmitting species A, C and E respectively during the first duration of the experimental run.

Any species of interest that do not have said sufficiently different elution time from the IMS device 3, as compared to the species that are transmitted in the first duration of the experimental run, are considered for being transmitted in a second duration of the experimental run. For example, if species A, C and E are transmitted by the mass filter 2 in the first duration of the experimental run then the remaining species B and D are considered for being transmitted by the mass filter in a second duration of the experimental run. The process described above is then repeated for these remaining species of interest B, D. For instance, it may be determined that during the second duration of the experimental run the mass filter should be provided with a first mass window so as to be capable of transmitting a first of the remaining species of interest, such as species B having the lowest mass to charge ratio. The other remaining species of interest (i.e. species D in this example) may then be examined to determine which of the species, if any, has the closest mass to charge ratio to the first of the remaining species B whilst having said sufficiently different elution time from the IMS device to species B. For example, species D may be determined to fulfil these conditions. As such, it may be determined that the mass filter should be simultaneously provided with first and second mass windows that are capable of transmitting species B and D respectively during the second duration of the experimental run. On the other hand, if it is determined that none of the remaining species of interest fulfils this condition then the mass filter is provided with only the mass transmission window for species B during the second duration of the experimental run. In this instance, the mass filter may then be provided with only a mass transmission window for species D during a third, different duration of the experimental run.

The spectrometer may have one or processor and electronic circuitry that automatically determines all of the permutations of the different combinations of species of interest that may be transmitted by the mass filter 2 simultaneously, whilst having said sufficiently different elution times from the IMS device 3. The spectrometer may then use this information to automatically select when during the experimental run the mass windows for the species of interest should be applied to the mass filter such that all precursor species of interest are transmitted during the experimental run. The spectrometer may perform this automatic selection such that the transmission of the species of interest by the mass filter is optimised. For example, the spectrometer may select the sequence in which the mass transmission windows are applied to the mass filter, including which mass transmission windows (for the species of interest) are applied simultaneously, so as to optimise the overall duty cycle for the transmission of the precursor ion species of interest. This may be achieved, for example, by using a Monte Carlo procedure. The spectrometer has control circuitry that controls the voltages applied to the mass filter so as to implement the determined sequence.

The spectrometer may have a processor and electronic circuitry so as to automatically perform any of the steps disclosed herein.

Although the present invention has been described with reference to various embodiments, it will be understood by those skilled in the art that various changes in form and detail may be made without departing from the scope of the invention as set forth in the accompanying claims.

For example, in order to increase the duty cycle of the spectrometer, the IMS device 3 may pulse ions into the separation region before the least mobile ions from the previous separation cycle have eluted from the IMS device. As such, sequential ion packets may be separated in the IMS device simultaneously.

Embodiments have been described in which a survey scan is performed. The survey scan may obtain mass spectral data that is indicative of the intensities and mass to charge ratios of the ions being supplied to the mass filter. The mass to charge ratio ranges of the mass transmission windows that are simultaneously applied to the mass filter may then be selected based on the intensities of the ions detected in the survey scan mode. Each of the intensities in the mass spectral data (for a plurality of ion species) may be converted into a rate of charge passing out of the mass filter for the corresponding ion species. The step of selecting the mass to charge ratio ranges of the mass transmission windows that are simultaneously applied to the mass filter may comprise selecting windows so as to transmit ions (corresponding to those detected in the survey scan mode) that have a combined rate of charge passing out of the mass filter that is below a preselected threshold value. This enables, for example, to ensure that space-charge effects do not become problematic in downstream devices, such as the IMS device.

In the survey scan mode the mass filter may be operated as an ion guide, i.e. so as to substantially not mass filter ions transmitted to it. The fragmentation or reaction device may also be deactivated in this mode, such that the precursor ions transmitted to the mass filter are mass analysed so as to obtain the mass spectral data. Alternatively, the fragmentation or reaction device may be activated in the survey scan mode and the intensities of the fragment or product ions (which are related to the intensities of their precursor ions) may be used to select the mass transmission windows that are simultaneously applied to the mass filter.

As described elsewhere herein, voltages are applied to the mass filter such that it simultaneously has multiple mass transmission windows that simultaneously transmit multiple respective precursor ion species, whilst filtering out other precursor ion species. The voltages that are applied to the mass filter may be selected such that, for at least one of the mass transmission windows, ions having a mass to charge ratio located at the centre of the window are transmitted by the mass filter with a relatively high transmission efficiency, whereas ions having a mass to charge ratio that is located within the window and closer to an edge of the window (such as proximate the edge) are transmitted by the mass filter with a lower transmission efficiency. The voltages may be applied to the mass filter such that the transmission efficiency for the ions progressively drops for mass to charge ratios located progressively closer, respectively, to an edge of the window. As such, the position of the window can be chosen to achieve the desired level of attenuation for ions of a selected mass to charge ratio. This effectively attenuates the selected precursor ion species which, for example, can help avoid space-charge effects downstream of the mass filter.

The voltages may be applied to the mass filter such that the transmission efficiency for the ions progressively drops for mass to charge ratios located progressively closer, respectively, to an edge of the window. As such, the position of the window can be chosen to achieve the desired level of attenuation for ions of a selected mass to charge ratio.

Although embodiments have been described in which the precursor ion species are separated in an IMS device 3 by their mobility, it is alternatively contemplated that the precursor ion species may be separated in an ion separator by mass to charge ratio.

Embodiments have been described in which the mass filter only transmits ions that have mass to charge ratios within the mass transmission windows and filters out substantially all ions having mass to charge ratios outside of the mass transmission windows. However, it is alternatively contemplated that the mass filter may only partially attenuate ions having mass to charge ratios that are outside of the mass transmission windows described, rather than fully attenuate these ions.

1. A method of mass spectrometry comprising:
providing a mass spectrometer comprising a mass filter, an ion mobility separator (IMS) device, a fragmentation or reaction device, and a mass analyser;
applying voltages to the mass filter such that it simultaneously has multiple mass transmission windows that simultaneously transmit multiple respective precursor ion species to the IMS device whilst filtering out other precursor ion species;
separating, in the IMS device, the precursor ion species that are simultaneously transmitted by the mass filter so as to provide different ones of the precursor ion species to the fragmentation or reaction device at different times;
sequentially fragmenting or reacting the different precursor ion species in the fragmentation or reaction device so as to form fragment or product ions;
detecting the fragment or product ions in the mass analyser; and
associating detected fragment or product ions with their respective precursor ion species based on the times of detection of the fragment or product ions in the mass analyser.

2. The method of claim 1, wherein the IMS device has an ion accumulation region and an ion separation region, and wherein the IMS device is controlled to accumulate the precursor ion species that are transmitted by the mass filter in the ion accumulation region and to then pulse the accumulated ions into the separation region such that the precursor ion species separate according to mobility so that different precursor ion species elute from the separation region at different times.

3. The method of any preceding claim, wherein the mass filter is a multipole mass filter, such as a quadrupole mass filter.

4. The method of any preceding claim, wherein the number of mass transmission windows that are simultaneously present in the mass filter is varied during a period whilst precursor ion species are substantially continually supplied to the mass filter.

5. The method of claim 4, wherein at least two mass transmission windows are simultaneously applied to the mass filter during a first duration of said period whilst precursor ion species are substantially continually supplied to the mass filter; and
(i) wherein only a single mass transmission window is provided during a second, different duration of said period, and/or (ii) wherein two or more mass transmission windows are simultaneously provided during a third duration of said period.

6. The method of any preceding claim, wherein different mass transmission windows are applied to the mass filter at different respective times during a period, or said period, whilst precursor ion species are substantially continually supplied to the mass filter, such that different precursor ion species of interest are transmitted by the mass filter at said different respective times.

7. The method of any preceding claim, comprising performing a survey scan mode in which mass spectral data is obtained that is indicative of the intensities and mass to charge ratios of the ions being supplied to the mass filter; and subsequently selecting the mass to charge ratio ranges of the mass transmission windows that are simultaneously applied to the mass filter based on the intensities of the ions detected in the survey scan mode.

8. The method of any preceding claim, wherein the voltages that are applied to the mass filter are selected such that, for at least one of the mass transmission windows and at any given time, the mass transmission window is configured to cause ions having a mass to charge ratio located at the centre of the window to transmitted by the mass filter with a relatively high transmission efficiency, and to cause ions having a mass to charge ratio that is located within the window and closer to an edge of the window to be transmitted by the mass filter with a lower transmission efficiency; and wherein the method comprises:
selecting a mass to charge ratio corresponding to that of one of said precursor ion species to be transmitted by the mass filter; and
applying said voltages to the mass filter such that said selected mass to charge ratio is located in the mass transmission window at a position that is off-centre or proximate an edge of the mass transmission window.

9. The method of any preceding claim, wherein the mass to charge ratio ranges of the mass transmission windows that are simultaneously applied to the mass filter are selected such that the different precursor ion species that are simultaneously transmitted by these mass transmission windows have average elution times from the IMS device that differ from each other by more than a pre-selected threshold value.

10. The method of any preceding claim, wherein the mass to charge ratio ranges of the mass transmission windows that are simultaneously applied to the mass filter are selected such that the different precursor ion species that are simultaneously transmitted by these mass transmission windows elute from the IMS device over different, non-overlapping time periods.

11. The method of any preceding claim, comprising:
selecting a set of multiple precursor ion species as being precursor ion species of interest that are to be analysed during a period in which precursor ion species are substantially continually supplied to the mass filter;
determining that the mass filter is to be provided with a first mass transmission window during said period for transmitting a first of the multiple precursor ion species of interest;
determining a second of the multiple precursor ion species of interest that has the closest mass to charge ratio to the first precursor ion species of interest, whilst also having an elution time from the IMS device that differs from the elution time from the IMS device of the first precursor ion species of interest by more than a pre-selected threshold value;
determining that the mass filter is to be provided with a second mass transmission window so as to be capable of transmitting the second precursor ion species of interest; and
simultaneously providing the mass filter with the first and second mass transmission windows.

12. The method of any claim 11 further comprising:
determining a third of the multiple precursor ion species of interest that has the closest mass to charge ratio to the second precursor ion species of interest, whilst also having an elution time from the IMS device that differs from the elution time from the IMS device of each of the first and second precursor ion species of interest by more than a pre-selected threshold value;
determining that the mass filter is to be provided with a third mass transmission window so as to be capable of transmitting the third precursor ion species of interest; and
simultaneously providing the mass filter with the first, second and third mass transmission windows.

13. The method of any claim 11 or 12, further comprising:
determining a further one of the multiple precursor ion species of interest that has an elution time from the IMS device that differs from the elution time from the IMS device of each of the first and second precursor ion species of interest, and optionally also the third precursor ion species of interest, by less than a pre-selected threshold value;
determining that the mass filter is to be provided with a further mass transmission window so as to be capable of transmitting said further one of the multiple precursor ion species of interest; and
providing the mass filter with said further mass transmission window at a different time during said period, in which precursor ion species are substantially continually supplied to the mass filter, to when the first and second, and optionally third, mass transmission windows are applied.

14. The method of any of claims 11, 12 or 13, wherein the spectrometer automatically performs steps comprising:
(i) determining the different combinations of said multiple precursor ion species of interest that may be transmitted by the mass filter simultaneously, where all of the precursor ion species of interest in each of the combinations have elution times from the IMS device that differ from each other by more than a pre-selected threshold;
(ii) selecting a plurality of said combinations that together include all of the multiple precursor ion species of interest; and
(iii) applying different mass transmission windows to the mass filter at different times such that different combinations of said plurality of combinations of precursor ion species of interest are transmitted by the mass filter at different respective times until all of the multiple precursor ion species of interest have been transmitted by the mass filter.

15. The method of any claim 14, wherein step (iii) comprises the spectrometer automatically selecting a time sequence in which the mass transmission windows are applied to the mass filter, including which mass transmission windows are applied simultaneously, so as to optimise the overall duty cycle for the transmission of the precursor ion species of interest; and then applying said sequence to the mass filter.

16. The method of any preceding claim, wherein any given fragment or product ion species detected at the mass analyser is correlated to its respective precursor ion species using the time that the fragment or product ion species was detected by the mass analyser and knowledge of the times that precursor ion species are known to have, or estimated to have, eluted from the IMS device.

17. A method of mass spectrometry comprising:
providing a mass spectrometer comprising a mass filter, a mass to charge ratio separator device, a fragmentation or reaction device, and a mass analyser;
applying voltages to the mass filter such that it simultaneously has multiple mass transmission windows that simultaneously transmit multiple respective precursor ion species to the separator device whilst filtering out other precursor ion species;
separating, in the separator device, the precursor ion species that are simultaneously transmitted by the mass filter so as to provide different ones of the precursor ion species to the fragmentation or reaction device at different times;
sequentially fragmenting or reacting the different precursor ion species in the fragmentation or reaction device so as to form fragment or product ions;
detecting the fragment or product ions in the mass analyser; and
associating detected fragment or product ions with their respective precursor ion species based on the times of detection of the fragment or product ions in the mass analyser.

18. The method of claim 17, wherein the mass filter is a multipole mass filter, such as a quadrupole mass filter.

19. The method of claim 17 or 18, wherein the separator device comprises a non-mass selective ion trap and an ion separation region, wherein the separator device is controlled to accumulate the precursor ion species that are simultaneously transmitted by the mass filter in the ion trap, to pulse the accumulated ions into the separation region substantially simultaneously, and to separate the precursor ion species according to mass to charge ratio within the separation region such that different precursor ion species elute from the separation region at different times.

20. The method of claim 17, 18 or 19, wherein all of the precursor ions are free to exit the downstream end of separator device whilst the ions are being separated by mass to charge ratio; and/or
wherein the precursor ions pass through and exit the separator device without having been urged in the downstream direction so as to be forced over a potential barrier.

21. The method of any one of claims 17-20, wherein the mass to charge ratio ranges of the mass transmission windows that are simultaneously applied to the mass filter are selected such that the different precursor ion species that are simultaneously transmitted by these mass transmission windows have average elution times from the separator device that differ from each other by more than a pre-selected threshold value.

22. The method of any one of claims 17-21, wherein the mass to charge ratio ranges of the mass transmission windows that are simultaneously applied to the mass filter are selected such that the different precursor ion species that are simultaneously transmitted by these mass transmission windows elute from the separator device over different, non-overlapping time periods.

23. The method of any one of claims 17-22, comprising:
selecting a set of multiple precursor ion species as being precursor ion species of interest that are to be analysed during a period in which precursor ion species are substantially continually supplied to the mass filter;
determining that the mass filter is to be provided with a first mass transmission window during said period for transmitting a first of the multiple precursor ion species of interest;
determining a second of the multiple precursor ion species of interest that has the closest mass to charge ratio to the first precursor ion species of interest, whilst also having an elution time from the separator device that differs from the elution time from the separator device of the first precursor ion species of interest by more than a pre-selected threshold value;
determining that the mass filter is to be provided with a second mass transmission window so as to be capable of transmitting the second precursor ion species of interest; and
simultaneously providing the mass filter with the first and second mass transmission windows.

24. The method of any claim 23, further comprising:
determining a further one of the multiple precursor ion species of interest that has an elution time from the separator device that differs from the elution time from the separator device of each of the first and second precursor ion species of interest by less than a pre-selected threshold value;
determining that the mass filter is to be provided with a further mass transmission window so as to be capable of transmitting said further one of the multiple precursor ion species of interest; and
providing the mass filter with said further mass transmission window at a different time during said period, in which precursor ion species are substantially continually supplied to the mass filter, to when the first and second mass transmission windows are applied.

25. The method of claim 23 or 24, wherein the spectrometer automatically performs steps comprising:
(i) determining the different combinations of said multiple precursor ion species of interest that may be transmitted by the mass filter simultaneously, where all of the precursor ion species of interest in each of the combinations have elution times from the separator device that differ from each other by more than a pre-selected threshold;
(ii) selecting a plurality of said combinations that together include all of the multiple precursor ion species of interest; and
(iii) applying different mass transmission windows to the mass filter at different times such that different combinations of said plurality of combinations of precursor ion species of interest are transmitted by the mass filter at different respective times until all of the multiple precursor ion species of interest have been transmitted by the mass filter.

26. The method of any one of claims 17-25, wherein the separation device is maintained at a pressure of ≥5 mbar.

27. A mass spectrometer comprising:
a mass filter;
a separator device, such as an ion mobility separator (IMS) device;
a fragmentation or reaction device;
a mass analyser; and
a processor and control circuitry configured to control the spectrometer to:
apply voltages to the mass filter such that it simultaneously has multiple mass transmission windows for simultaneously transmitting multiple respective precursor ion species to the separator device whilst filtering out other precursor ion species;
separate, in the separator device, the precursor ion species that are simultaneously transmitted by the mass filter so as to provide different ones of the precursor ion species to the fragmentation or reaction device at different times;
sequentially fragment or react the different precursor ion species in the fragmentation or reaction device so as to form fragment or product ions;
detect the fragment or product ions in the mass analyser; and
associate detected fragment or product ions with their respective precursor ion species based on the times of detection of the fragment or product ions in the mass analyser.

28. A method of mass spectrometry comprising:
providing a mass spectrometer comprising a mass filter, a separator device, a fragmentation or reaction device, and a mass analyser;
applying voltages to the mass filter such that it simultaneously transmits precursor ions having mass to charge ratios in a first set of mass transmission windows, whilst also simultaneously attenuating and transmitting precursor ions having mass to charge ratios in a second set of mass transmission windows;
separating, in the separator device, precursor ion species that are simultaneously transmitted by the mass filter so as to provide different ones of the precursor ion species to the fragmentation or reaction device at different times;
sequentially fragmenting or reacting the different precursor ion species in the fragmentation or reaction device so as to form fragment or product ions;
detecting the fragment or product ions in the mass analyser; and
associating detected fragment or product ions with their respective precursor ion species based on the times of detection of the fragment or product ions in the mass analyser.
